(19) United States
(12) Patent Application Publication
(10) Pub. No.: US 2016/0371339 A1
(43) Pub. Date: Dec. 22, 2016

(54) EXECUTING A FACETED SEARCH WITHIN A SEMI-STRUCTURED DATABASE USING A BLOOM FILTER

(71) Applicant: QUALCOMM Incorporated, San Diego, CA (US)

(72) Inventors: Michael William PADDON, Tokyo (JP); Xavier Claude FRANC, Sarthe (FR); Craig Matthew BROWN, New South Wales (AU); Matthew Christian DUGGAN, Tokyo (JP)

(21) Appl. No.: 14/864,487

(22) Filed: Sep. 24, 2015

Related U.S. Application Data
(60) Provisional application No. 62/180,947, filed on Jun. 17, 2015.

(51) Int. Cl. G06F 17/30

(52) U.S. Cl. CPC G06F 17/30522; G06F 17/30395

(57) ABSTRACT

In an embodiment, a server executes a first query in a semi-structured database to determine a first list of nodes that each include at least one node-specific data entry that satisfies the first query. The server initializes a Bloom filter with the first list of nodes. The server filters a list of candidate nodes for a second query based on the Bloom filter. The server executes, in conjunction with a faceted search procedure of a set of documents in the semi-structured database, a second query that uses the filtered list of candidate nodes as a facet to determine a second list of nodes that each includes one or more node-specific data entries from the facet that satisfy the second query.

### CROSS-REFERENCE TO RELATED APPLICATION

The present application for patent claims the benefit to U.S. Provisional Application No. 62/180,947, entitled “EXECUTING A FACETED SEARCH WITHIN A SEMI-STRUCTURED DATABASE USING A BLOOM FILTER”, filed Jun. 17, 2015, assigned to the assignee hereof, and expressly incorporated herein by reference in its entirety.

### BACKGROUND

1. Field

This disclosure relates to executing a faceted search within a semi-structured database using a Bloom filter.

2. Description of the Related Art

Databases can store and index data in accordance with a structured data format (e.g., Relational Databases for normalized data queried by Structured Query Language (SQL), etc.), a semi-structured data format (e.g., XMLDBs for Extensible Markup Language (XML) data, RethinkDB for JavaScript Object Notation (JSON) data, etc.) or an unstructured data format (e.g., Key Value Stores for key-value data, ObjectDBs for object data, Solr for free text indexing, etc.). In structured databases, any new data objects to be added are expected to conform to a fixed or predetermined schema (e.g., a new Company data object may be required to be added with Name, Industry and Headquarters values, a new Bibliography data object may be required to be added with Author, Title, Journal and Date values, and so on). By contrast, in unstructured databases, new data objects can be added verbatim, so similar data objects can be added via different formats which may cause difficulties in establishing semantic relationships between the similar data objects.

Semi-structured databases share some properties with both structured and unstructured databases (e.g., similar data objects can be grouped together as in structured databases, while the various values of the grouped data objects are allowed to differ which is more similar to unstructured databases). Semi-structured database formats use a document structure that includes a plurality of nodes arranged in a tree hierarchy. The document structure includes any number of data objects that are each mapped to a particular node in the tree hierarchy, whereby the data objects are indexed either by the name of their associated node (i.e., flat-indexing) or by their unique path from a root node of the tree hierarchy to their associated node (i.e., label-path indexing). The manner in which the data objects of the document structure are indexed affects how searches (or queries) are conducted.

### SUMMARY

An example relates to a method of performing a search within a semi-structured database that is storing a set of documents, each document in the set of documents being organized with a tree-structure that contains a plurality of nodes, the plurality of nodes for each document in the set of documents including a root node and at least one non-root node, each of the plurality of nodes including a set of node-specific data entries. The example method may include executing, among the set of documents, a first query to determine a first list of nodes that each include at least one node-specific data entry that satisfies the first query. The example method may further includes initializing a Bloom filter with the first list of nodes, and filtering a list of candidate nodes for a second query based on the Bloom filter. The example method may further includes executing, in conjunction with a faceted search procedure of the set of documents, the second query that uses the filtered list of candidate nodes as a facet to determine a second list of nodes that each includes one or more node-specific data entries from the facet that satisfy the second query.

Another example relates to server that is configured to perform a search within a semi-structured database that is storing a set of documents, each document in the set of documents being organized with a tree-structure that contains a plurality of nodes, the plurality of nodes for each document in the set of documents including a root node and at least one non-root node, each of the plurality of nodes including a set of node-specific data entries. The server may include means for executing, among the set of documents, a first query to determine a first list of nodes that each include at least one node-specific data entry that satisfies the first query, means for initializing a Bloom filter with the first list of nodes, means for filtering a list of candidate nodes for a second query based on the Bloom filter and means for executing, in conjunction with a faceted search procedure of the set of documents, the second query that uses the filtered list of candidate nodes as a facet to determine a second list of nodes that each includes one or more node-specific data entries from the facet that satisfy the second query.

Another example relates to server that is configured to perform a search within a semi-structured database that is storing a set of documents, each document in the set of documents being organized with a tree-structure that contains a plurality of nodes, the plurality of nodes for each document in the set of documents including a root node and at least one non-root node, each of the plurality of nodes including a set of node-specific data entries. The server may include logic configured to execute, among the set of documents, a first query to determine a first list of nodes that each include at least one node-specific data entry that satisfies the first query, logic configured to initialize a Bloom filter with the first list of nodes, logic configured to filter a list of candidate nodes for a second query based on the Bloom filter and logic configured to execute, in conjunction with a faceted search procedure of the set of documents, the second query that uses the filtered list of candidate nodes as a facet to determine a second list of nodes that each includes one or more node-specific data entries from the facet that satisfy the second query.

Another example relates to a non-transitory computer-readable medium containing instructions stored thereon, which, when executed by a server that is configured to perform a search within a semi-structured database that is storing a set of documents, each document in the set of documents being organized with a tree-structure that contains a plurality of nodes, the plurality of nodes for each document in the set of documents including a root node and at least one non-root node, each of the plurality of nodes including a set of node-specific data entries, cause the server to perform operations. The instructions stored on the non-transitory computer-readable medium may include at least one instruction to cause the server to execute, among the set of documents, a first query to determine a first list of nodes that each include at least one node-specific data entry that satisfies the first query, at least one instruction to cause the server to initialize a Bloom filter with the first list of nodes, at least one instruction to cause the server to filter a list of candidate nodes for a second query based on the Bloom filter and at least one instruction to cause the server to execute, in conjunction with a faceted search procedure of the set of documents, the second query that uses the filtered list of candidate nodes as a facet to determine a second list of nodes that each includes one or more node-specific data entries from the facet that satisfy the second query.

### BRIEF DESCRIPTION OF THE DRAWINGS

A more complete appreciation of embodiments of the disclosure will be readily obtained as the same becomes better understood by reference to the following detailed description when considered in connection with the accompanying drawings which are presented solely for illustration and not limitation of the disclosure, and in which:

FIG. 1 illustrates a high-level system architecture of a wireless communications system in accordance with an embodiment of the disclosure.

FIG. 2 illustrates examples of user equipments (UEs) in accordance with embodiments of the disclosure.

FIG. 3 illustrates a communication device that includes logic configured to perform functionality in accordance with an embodiment of the disclosure.

FIG. 4 illustrates a server in accordance with an embodiment of the disclosure.

FIG. 5A illustrates an example of nodes in a tree hierarchy for a given document in accordance with an embodiment of the disclosure.

FIG. 5B illustrates an example of a context tree for the document depicted in FIG. 5A in accordance with an embodiment of the disclosure.

FIG. 5C illustrates another example of a context tree in accordance with another embodiment of the disclosure.

FIG. 6A illustrates a more detailed example of the tree hierarchy depicted in FIG. 5A in accordance with another embodiment of the disclosure.

FIG. 6B illustrates a flat element index for an XML database in accordance with an embodiment of the disclosure.

FIG. 6C illustrates a context tree for an XML database in accordance with an embodiment of the disclosure.

FIG. 7 illustrates a conventional faceted search procedure that is performed on a set of documents in a semi-structured database.

FIG. 8 illustrates a facet prompt screen associated with a faceted search procedure of a semi-structured database in accordance with an embodiment of the disclosure.

FIG. 9 illustrates a faceted search procedure that is performed on a set of documents in a semi-structured database in accordance with an embodiment of the disclosure.

FIG. 10 illustrates a more detailed implementation example of the process of FIG. 9 in accordance with at least one embodiment of the disclosure.

### DETAILED DESCRIPTION

Aspects of the disclosure are disclosed in the following description and related drawings directed to specific embodiments of the disclosure. Alternate embodiments may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any embodiment described herein as “exemplary” and/or “example” is not necessarily to be construed as preferred or advantageous over other embodiments. Likewise, the term “embodiments of the disclosure” does not require that all embodiments of the disclosure include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A client device, referred to herein as a user equipment (UE), may be mobile or stationary, and may communicate with a wired access network and/or a radio access network (RAN). As used herein, the term “UE” may be referred to interchangeably as an “access terminal” or “AT”, a “wireless device”, a “subscriber device”, a “subscriber terminal”, a “subscriber station”, a “user terminal” or UT, a “mobile terminal”, a “mobile station” and variations thereof. In an embodiment, UEs can communicate with a core network via a RAN, and through the core network the UEs can be connected with external networks such as the Internet. Of course, other mechanisms of connecting to the core network and/or the Internet are also possible for the UEs, such as over wired access networks, WiFi networks (e.g., based on IEEE 802.11, etc.) and so on. UEs can be embodied by any of a number of types of devices including but not limited to cellular telephones, personal digital assistants (PDAs), pagers, laptop computers, desktop computers, PC cards, compact flash devices, external or internal modems, wireless or wireline phones, and so on. A communication link through which UEs can send signals to the RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

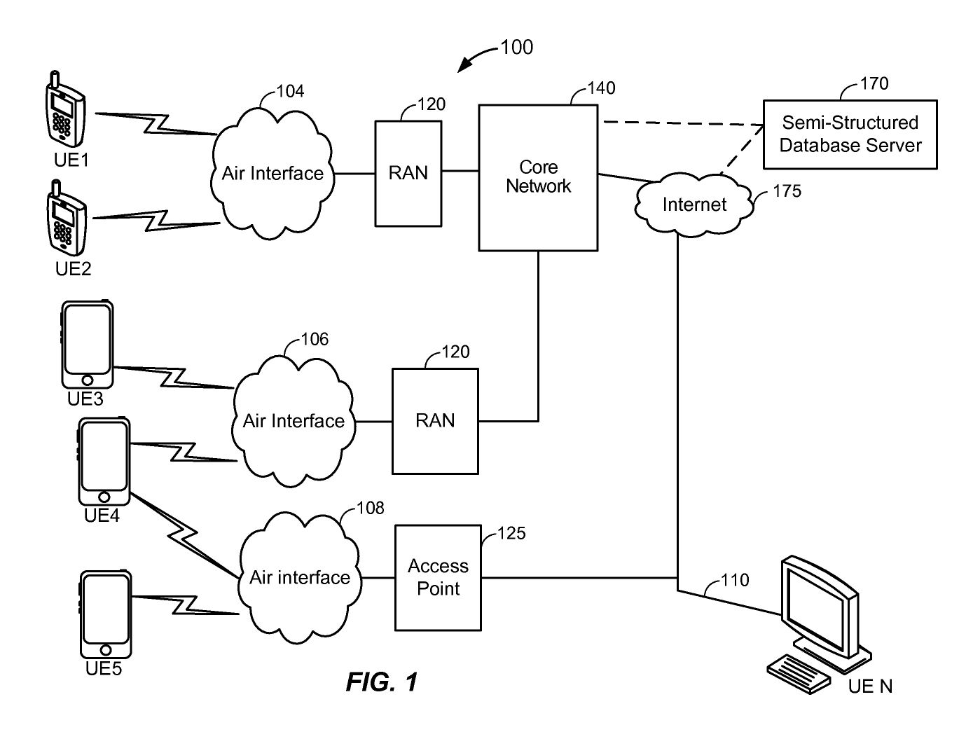

FIG. 1 illustrates a high-level system architecture of a wireless communications system 100 in accordance with an embodiment of the disclosure. The wireless communications system 100 contains UEs 1 . . . N. For example, in FIG. 1, UEs 1 . . . 2 are illustrated as cellular calling phones, UEs 3 . . . 5 are illustrated as cellular touchscreen phones or smart phones, and UE N is illustrated as a desktop computer or PC.

Referring to FIG. 1, UEs 1 . . . N are configured to communicate with an access network (e.g., a RAN 120, an access point 125, etc.) over a physical communications interface or layer, shown in FIG. 1 as air interfaces 104, 106, 108 and/or a direct wired connection 110. The air interfaces 104 and 106 can comply with a given cellular communications protocol (e.g., CDMA, EVDO, eHRPD, GSM, EDGE, W-CDMA, LTE, etc.), while the air interface 108 can comply with a wireless IP protocol (e.g., IEEE 802.11). The RAN 120 may include a plurality of access points that serve UEs over air interfaces, such as the air interfaces 104 and 106. The access points in the RAN 120 can be referred to as access nodes or ANs, access points or APs, base stations or BSs, Node Bs, eNode Bs, and so on. These access points can be terrestrial access points (or ground stations), or satellite access points. The RAN 120 may be configured to connect to a core network 140 that can perform a variety of functions, including bridging circuit-switched (CS) calls between UEs served by the RAN 120 and other UEs served by the RAN 120 or a different RAN altogether, and may also mediate an exchange of packet-switched (PS) data with external networks such as Internet 175.

The Internet 175, in some examples, includes a number of routing agents and processing agents (not shown in FIG. 1 for the sake of convenience). In FIG. 1, UE N is shown as connecting to the Internet 175 directly (i.e., separate from the core network 140, such as over an Ethernet connection of WiFi or 802.11-based network). The Internet 175 can thereby function to bridge packet-switched data communications between UEs 1 . . . N via the core network 140. Also shown in FIG. 1 is the access point 125 that is separate from the RAN 120. The access point 125 may be connected to the Internet 175 independent of the core network 140 (e.g., via an optical communications system such as FiOS, a cable modem, etc.). The air interface 108 may serve UE 4 or UE 5 over a local wireless connection, such as IEEE 802.11 in an example. UE N is shown as a desktop computer with a wired connection to the Internet 175, such as a direct connection to a modem or router, which can correspond to the access point 125 itself in an example (e.g., for a WiFi router with both wired and wireless connectivity).

Referring to FIG. 1, a semi-structured database server 170 is shown as connected to the Internet 175, the core network 140, or both. The semi-structured database server 170 can be implemented as a plurality of structurally separate servers (i.e., a distributed server arrangement), or alternately may correspond to a single server. The semi-structured database server 170 is responsible for maintaining a semi-structured database (e.g., an XML database, a JavaScript Object Notation (JSON) database, etc.) and executing search queries within the semi-structured database on behalf of one or more client devices, such as UEs 1 . . . N as depicted in FIG. 1. In some implementations, the semi-structured database server 170 can execute on one or more of the client devices as opposed to a network server, in which case the various client devices can interface with the semi-structured database server 170 via network connections as depicted in FIG. 1, or alternatively via local or peer-to-peer interfaces. In another example, the semi-structured database server 170 can run as an embedded part of an application on a device (e.g., a network server, a client device or UE, etc.). In this case, where the semi-structured database server 170 is implemented as an application that manages the semi-structured database, the application can operate without the need for inter-process communication between other applications on the device.

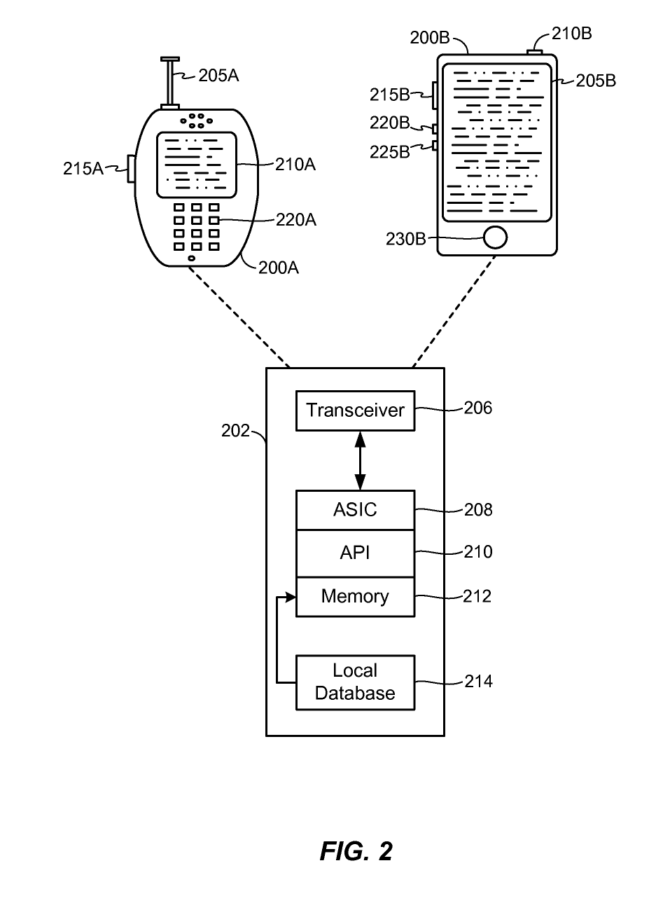

FIG. 2 illustrates examples of UEs (i.e., client devices) in accordance with embodiments of the disclosure. Referring to FIG. 2, UE 200A is illustrated as a calling telephone and UE 200B is illustrated as a touchscreen device (e.g., a smart phone, a tablet computer, etc.). As shown in FIG. 2, an external casing of UE 200A is configured with an antenna 205A, display 210A, at least one button 215A (e.g., a PTT button, a power button, a volume control button, etc.) and a keypad 220A among other components, as is known in the art. Also, an external casing of UE 200B is configured with a touchscreen display 205B, peripheral buttons 210B, 215B, 220B and 225B (e.g., a power control button, a volume or vibrate control button, an airplane mode toggle button, etc.), and at least one front-panel button 230B (e.g., a Home button, etc.), among other components, as is known in the art. While not shown explicitly as part of UE 200B, UE 200B can include one or more external antennas and/or one or more integrated antennas that are built into the external casing of UE 200B, including but not limited to WiFi antennas, cellular antennas, satellite position system (SPS) antennas (e.g., global positioning system (GPS) antennas), and so on.

While internal components of UEs such as UEs 200A and 200B can be embodied with different hardware configurations, a basic high-level UE configuration for internal hardware components is shown as platform 202 in FIG. 2. The platform 202 can receive and execute software applications, data and/or commands transmitted from the RAN 120 that may ultimately come from the core network 140, the Internet 175 and/or other remote servers and networks (e.g., the semi-structured database server 170, web URLs, etc.). The platform 202 can also independently execute locally stored applications without RAN interaction. The platform 202 can include a transceiver 206 operably coupled to an application specific integrated circuit (ASIC) 208, or other processor, microprocessor, logic circuit, or other data processing device. The ASIC 208 or other processor executes the application programming interface (API) 210 layer that interfaces with any resident programs in a memory 212 of the wireless device. The memory 212 can be comprised of read-only or random-access memory (RAM and ROM), EEPROM, flash cards, or any memory common to computer platforms. The platform 202 also can include a local database 214 that can store applications not actively used in the memory 212, as well as other data. The local database 214 is typically a flash memory cell, but can be any secondary storage device as known in the art, such as magnetic media, EEPROM, optical media, tape, soft or hard disk, or the like.

Accordingly, an embodiment of the disclosure can include a UE (e.g., UE 200A, 200B, etc.) including the ability to perform the functions described herein. As will be appreciated by those skilled in the art, the various logic elements can be embodied in discrete elements, software modules executed on a processor or any combination of software and hardware to achieve the functionality disclosed herein. For example, the ASIC 208, the memory 212, the API 210 and the local database 214 may all be used cooperatively to load, store and execute the various functions disclosed herein and thus the logic to perform these functions may be distributed over various elements. Alternatively, the functionality could be incorporated into one discrete component. Therefore, the features of UEs 200A and 200B in FIG. 2 are to be considered merely illustrative and the disclosure is not limited to the illustrated features or arrangement.

The wireless communications between UEs 200A and/or 200B and the RAN 120 can be based on different technologies, such as CDMA, W-CDMA, time division multiple access (TDMA), frequency division multiple access (FDMA), Orthogonal Frequency Division Multiplexing (OFDM), GSM, or other protocols that may be used in a wireless communications network or a data communications network. As discussed in the foregoing and known in the art, voice transmission and/or data can be transmitted to the UEs from the RAN using a variety of networks and configurations. Accordingly, the illustrations provided herein are not intended to limit the embodiments of the disclosure and are merely to aid in the description of aspects of embodiments of the disclosure.

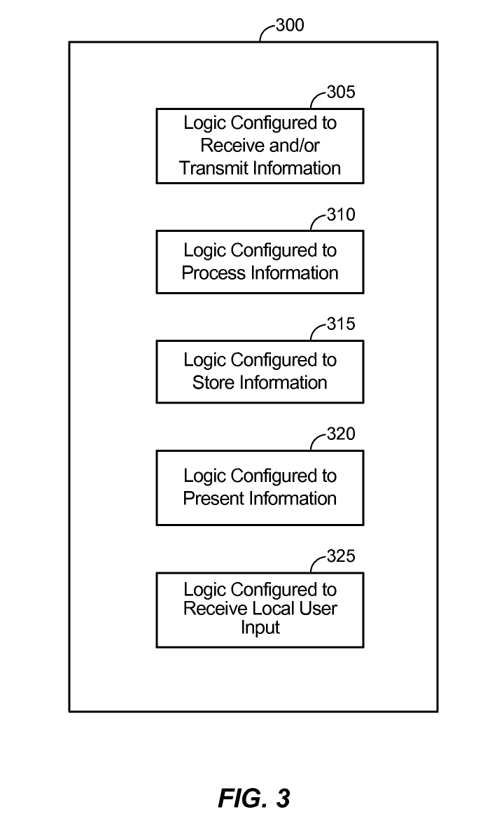

FIG. 3 illustrates a communications device 300 that includes logic configured to perform functionality in accordance with an embodiment of the disclosure. The communications device 300 can correspond to any of the above-noted communications devices, including but not limited to UEs 200A or 200B, any component of the RAN 120, any component of the core network 140, any components coupled with the core network 140 and/or the Internet 175 (e.g., the semi-structured database server 170), and so on. Thus, the communications device 300 can correspond to any electronic device that is configured to communicate with (or facilitate communication with) one or more other entities over the wireless communications system 100 of FIG. 1.

Referring to FIG. 3, the communications device 300 includes logic configured to receive and/or transmit information 305. In some embodiments such as when the communications device 300 corresponds to a wireless communications device (e.g., UE 200A or 200B, the access point 125, a BS, Node B or eNodeB in the RAN 120, etc.), the logic configured to receive and/or transmit information 305 can include a wireless communications interface (e.g., Bluetooth, WiFi, 2G, CDMA, W-CDMA, 3G, 4G, LTE, etc.) such as a wireless transceiver and associated hardware (e.g., an RF antenna, a MODEM, a modulator and/or demodulator, etc.). In another example, the logic configured to receive and/or transmit information 305 can correspond to a wired communications interface (e.g., a serial connection, a USB or Firewire connection, an Ethernet connection through which the Internet 175 can be accessed, etc.). For example, the communications device 300 may correspond to some type of network-based server (e.g., the semi-structured database server 170, etc.), and the logic configured to receive and/or transmit information 305 can correspond to an Ethernet card that connects the network-based server to other communication entities via an Ethernet protocol.

In a further example, the logic configured to receive and/or transmit information 305 can include sensory or measurement hardware by which the communications device 300 can monitor its local environment (e.g., an accelerometer, a temperature sensor, a light sensor, an antenna for monitoring local RF signals, etc.). The logic configured to receive and/or transmit information 305 can also include software that, when executed, permits the associated hardware of the logic configured to receive and/or transmit information 305 to perform its reception and/or transmission function(s). However, in various implementations, the logic configured to receive and/or transmit information 305 does not correspond to software alone, and the logic configured to receive and/or transmit information 305 relies at least in part upon hardware to achieve its functionality.

The communications device 300 of FIG. 3 may further include logic configured to process information 310. In an example, the logic configured to process information 310 can include at least a processor. Example implementations of the type of processing that can be performed by the logic configured to process information 310 includes but is not limited to performing determinations, establishing connections, making selections between different information options, performing evaluations related to data, interacting with sensors coupled to the communications device 300 to perform measurement operations, converting information from one format to another (e.g., between different protocols such as .wmv to .avi, etc.), and so on. For example, the processor included in the logic configured to process information 310 can correspond to a general purpose processor, a digital signal processor (DSP), an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The logic configured to process information 310 can also include software that, when executed, permits the associated hardware of the logic configured to process information 310 to perform its processing function(s). However, in various implementations, the logic configured to process information 310 does not correspond to software alone, and the logic configured to process information 310 relies at least in part upon hardware to achieve its functionality.

The communications device 300 of FIG. 3 may further include logic configured to store information 315. In an example, the logic configured to store information 315 can include at least a non-transitory memory and associated hardware (e.g., a memory controller, etc.). For example, the non-transitory memory included in the logic configured to store information 315 can correspond to RAM memory, flash memory, ROM memory, EPROM memory, EEPROM memory, registers, hard disk, a removable disk, a CD-ROM, or any other form of storage medium known in the art. The logic configured to store information 315 can also include software that, when executed, permits the associated hardware of the logic configured to store information 315 to perform its storage function(s). However, in various implementations, the logic configured to store information 315 does not correspond to software alone, and the logic configured to store information 315 relies at least in part upon hardware to achieve its functionality.

The communications device 300 of FIG. 3 may further include logic configured to present information 320. In an example, the logic configured to present information 320 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communications device 300. For example, if the communications device 300 corresponds to UE 200A or UE 200B as shown in FIG. 2, the logic configured to present information 320 can include the display 210A of UE 200A or the touchscreen display 205B of UE 200B. In a further example, the logic configured to present information 320 can be omitted for certain communications devices, such as network communications devices that do not have a local user (e.g., network switches or routers, remote servers such as the semi-structured database server 170, etc.). The logic configured to present information 320 can also include software that, when executed, permits the associated hardware of the logic configured to present information 320 to perform its presentation function(s). However, in various implementations, the logic configured to present information 320 does not correspond to software alone, and the logic configured to present information 320 relies at least in part upon hardware to achieve its functionality.

The communications device 300 of FIG. 3 may further include logic configured to receive local user input 325. In an example, the logic configured to receive local user input 325 can include at least a user input device and associated hardware. For example, the user input device can include buttons, a touchscreen display, a keyboard, a camera, an audio input device (e.g., a microphone or a port that can carry audio information such as a microphone jack, etc.), and/or any other device by which information can be received from a user or operator of the communications device 300. For example, if the communications device 300 corresponds to UE 200A or UE 200B as shown in FIG. 2, the logic configured to receive local user input 325 can include the keypad 220A, any of the buttons 215A or 210B through 225B, the touchscreen display 205B, etc. In a further example, the logic configured to receive local user input 325 can be omitted for certain communications devices, such as network communications devices that do not have a local user (e.g., network switches or routers, remote servers such as the semi-structured database server 170, etc.). The logic configured to receive local user input 325 can also include software that, when executed, permits the associated hardware of the logic configured to receive local user input 325 to perform its input reception function(s). However, in various implementations, the logic configured to receive local user input 325 does not correspond to software alone, and the logic configured to receive local user input 325 relies at least in part upon hardware to achieve its functionality.

Referring to FIG. 3, while the configured logics 305 through 325 are shown as separate or distinct blocks in FIG. 3, it will be appreciated that the hardware and/or software by which the respective configured logics 305 through 325 performs its functionality can overlap in part or as a whole. For example, any software used to facilitate the functionality of the configured logics 305 through 325 can be stored in the non-transitory memory associated with the logic configured to store information 315, such that the configured logics 305 through 325 each performs their functionality (i.e., in this case, software execution) based in part upon the operation of software stored by the logic configured to store information 315. Likewise, hardware that is directly associated with one of the configured logics 305 through 325 can be borrowed or used by other configured logics from time to time. For example, the processor of the logic configured to process information 310 can format data into an appropriate format before being transmitted by the logic configured to receive and/or transmit information 305, such that the logic configured to receive and/or transmit information 305 performs its functionality (i.e., in this case, transmission of data) based in part upon the operation of hardware (i.e., the processor) associated with the logic configured to process information 310.

Generally, unless stated otherwise explicitly, the phrase “logic configured to” as used throughout this disclosure is intended to invoke an embodiment that is at least partially implemented with hardware, and is not intended to map to software-only implementations that are independent of hardware. Also, it will be appreciated that the configured logic or “logic configured to” in the various blocks are not limited to specific logic gates or elements, but generally refer to the ability to perform the functionality described herein (either via hardware or a combination of hardware and software). Thus, the configured logics or “logic configured to” as illustrated in the various blocks are not necessarily implemented as logic gates or logic elements despite sharing the word “logic.” Other interactions or cooperation between the logic in the various blocks will become clear to one of ordinary skill in the art from a review of the embodiments described below in more detail.

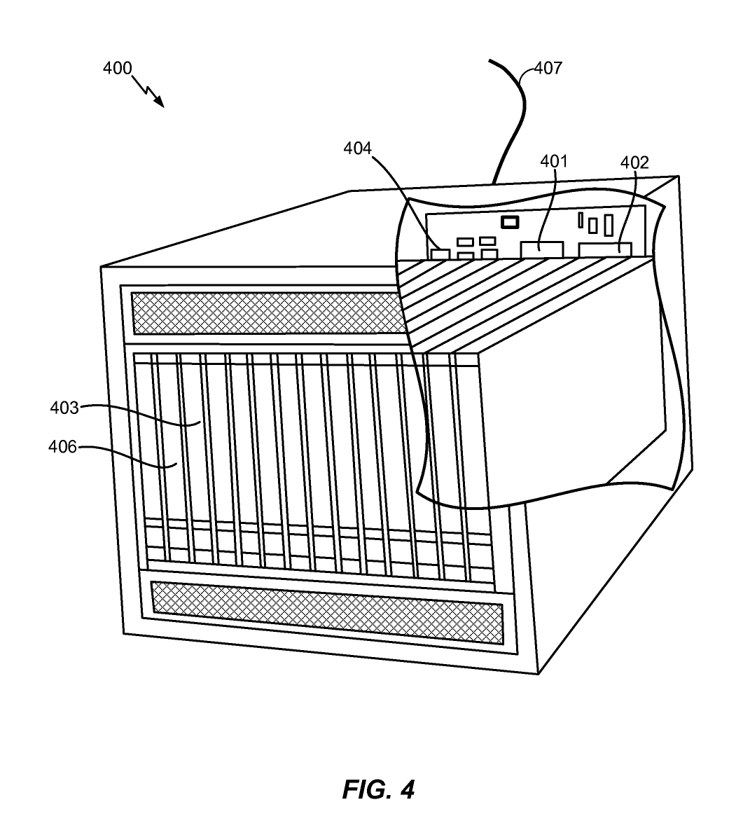

The various embodiments may be implemented on any of a variety of commercially available server devices, such as server 400 illustrated in FIG. 4. In an example, the server 400 may correspond to one example configuration of the semi-structured database server 170 described above. The server 400 may include a processor 401 coupled to a volatile memory 402 and a large capacity nonvolatile memory, such as a disk drive 403. The server 400 may also include a memory 406 (e.g., a floppy disc drive, compact disc (CD), a DVD disc drive, etc.) coupled to the processor 401. The server 400 may also include network access ports 404 coupled to the processor 401 for establishing data connections with a network via network connector 407, such as a local area network coupled to other broadcast system computers and servers or to the Internet. In context with FIG. 3, it will be appreciated that the server 400 of FIG. 4 illustrates one example implementation of the communications device 300, whereby the logic configured to transmit and/or receive information 305 corresponds to the network access ports 404 used by the server 400 to communicate via network connector 407, the logic configured to process information 310 corresponds to the processor 401, and the logic configured to store information 315 corresponds to any combination of the memory 406. The logic configured to present information 320 and the logic configured to receive local user input 325 are not shown explicitly in FIG. 4 and may or may not be included therein. Thus, FIG. 4 helps to demonstrate that the communications device 300 may be implemented as a server, in addition to a UE implementation as in FIG. 2.

Databases can store and index data in accordance with a structured data format (e.g., Relation Databases for normalized data queried by Structured Query Language (SQL), etc.), a semi-structured data format (e.g., XMLDBs for Extensible Markup Language (XML) data, RethinkDB for JavaScript Object Notation (JSON) data, etc.) or an unstructured data format (e.g., Key Value Stores for key-value data, ObjectDBs for object data, Solr for free text indexing, etc.). In structured databases, any new data objects to be added are expected to conform to a fixed or predetermined schema (e.g., a new Company data object may be required to be added with “Name”, “Industry” and “Headquarters” values, a new Bibliography data object may be required to be added with “Author”, “Title”, “Journal” and “Date” values, and so on). By contrast, in unstructured databases, new data objects are added verbatim, which permits similar data objects to be added via different formats which causes difficulties in establishing semantic relationships between the similar data objects.

Examples of structured database entries for a set of data objects may be configured as follows:

TABLE 1
Example of Structured Database Entry for a Company Data Object

| Name | Industry | Headquarters |
|---|---|---|
| Company X | Semiconductor; Wireless | San Diego, |
| | Telecommunications | California, USA |

whereby “Name”, “Industry” and “Headquarters” are predetermined values that are associated with each “Company”-type data object stored in the structured database, or

TABLE 2
Example of Structured Database Entry
for Bibliography Data Objects

| Author | Title | Journal | Date |
|---|---|---|---|
| Cox, J. | Company X races to retool | Network World | 2007 |
| | the mobile phone | | |
| Arensman, | Meet the New Company X | Electronic Business | 2000 |
| Russ | | | |

whereby “Author”, “Title”, “Journal” and “Date” are predetermined values that are associated with each “Bibliography”-type data object stored in the structured database.

Examples of unstructured database entries for the set of data objects may be configured as follows:

TABLE 3
Example of Unstructured Database
Entry for a Company Data Object

Company X is an American global semiconductor company that designs
and markets wireless telecommunications products and services. The
company headquarters are located in San Diego, California, USA.

TABLE 4
Example of Unstructured Database Entry
for Bibliography Data Objects

Cox, J. (2007). ‘Company X races to retool the mobile phone’.
Network World, 24/8: 26.
Arensman, Russ. “Meet the New Company X.” Electronic Business,
Mar. 1, 2000.

As will be appreciated, the structured and unstructured databases in Tables 1 and 3 and in Tables 2 and 4 store substantially the same information, with the structured database having a rigidly defined value format for the respective class of data object while the unstructured database does not have defined values associated for data object classes.

Semi-structured databases share some properties with both structured and unstructured databases (e.g., similar data objects can be grouped together as in structured databases, while the various values of the grouped data objects are allowed to differ which is more similar to unstructured databases). Semi-structured database formats use a document structure that includes a set of one or more documents that each have a plurality of nodes arranged in a tree hierarchy. The plurality of nodes are generally implemented as logical nodes (e.g., the plurality of nodes can reside in a single memory and/or physical device), although it is possible that some of the nodes are deployed on different physical devices (e.g., in a distributed server environment) so as to qualify as both distinct logical and physical nodes. Each document includes any number of data objects that are each mapped to a particular node in the tree hierarchy, whereby the data objects are indexed either by the name of their associated node (i.e., flat-indexing) or by their unique path from a root node of the tree hierarchy to their associated node (i.e., label-path indexing). The manner in which the data objects of the document structure are indexed affects how searches (or queries) are conducted.

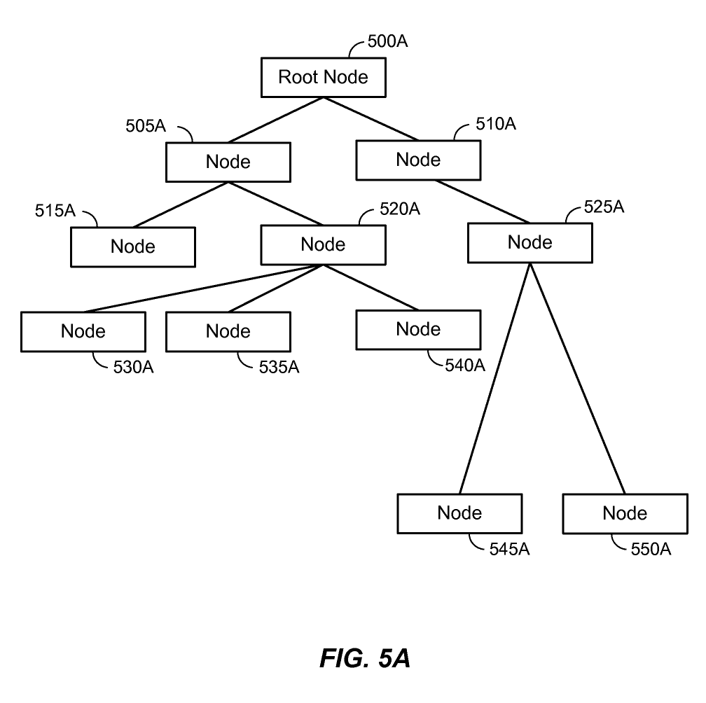

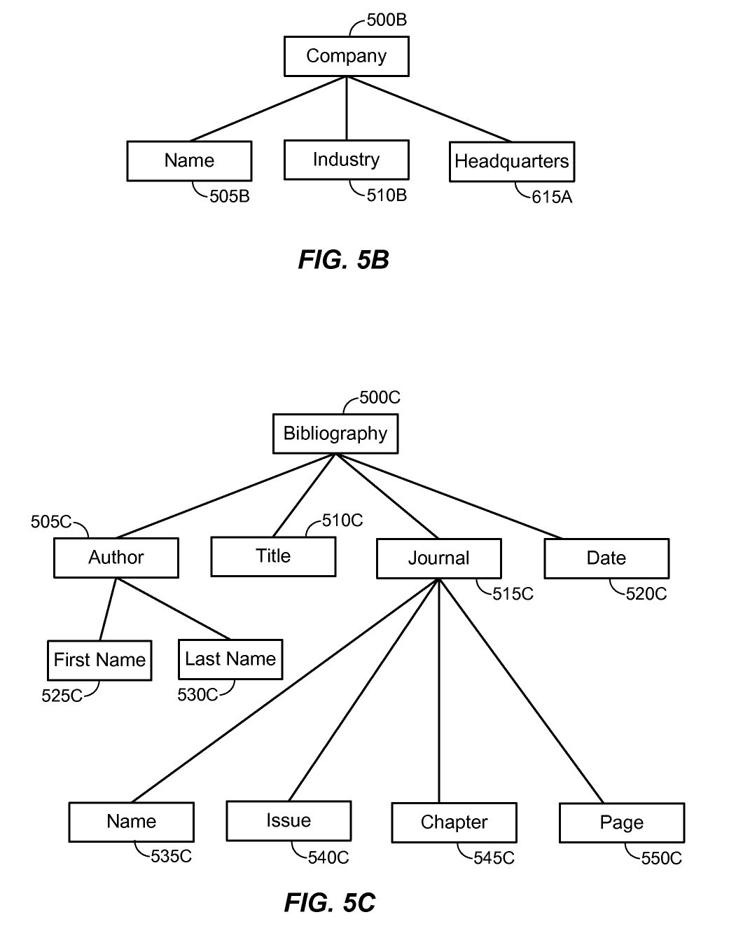

FIG. 5A illustrates a set of nodes in a tree hierarchy for a given document in accordance with an embodiment of the disclosure. As illustrated, a root node 500A contains descendant nodes 505A and 510A, which in turn contain descendant nodes 515A, 520A and 525A, respectively, which in turn contain descendant nodes 530A, 535A, 540A, 545A and 550A, respectively.

FIGS. 5B-5C illustrate examples of context trees for example documents in accordance with various embodiments of the disclosure. With respect to at least FIGS. 5B-5C, references to context paths and context trees are made below, with these terms being defined as follows:
Context Path: One node in a context tree.
Context Tree: The complete set of all paths in a set of documents.

FIG. 5B illustrates an example of the context tree for a “Company” document based on the data from Tables 1 and 3 (above). Referring to FIG. 5B, there is a root context path “Company” 500B, and three descendant context paths 505B, 510B, 515B for “Name”, “Industry” and “Headquarters” values, respectively. For a JSON-based semi-structured database, the data object depicted above in Tables 1 and 3 may be recorded as follows:

TABLE 5
Example of JSON-based Semi-Structured Database
Entry for a Company Data Object

```
{
  “Company”: “Company X”,
  “Industry”: [
```

“Semiconductor”,
“Wireless telecommunications” ],

“Headquarters” :

“San Diego, California, USA”

}

FIG. 5C illustrates an example of the context tree for a “Bibliography” document based on the data from Tables 2 and 4 (above). Referring to FIG. 5C, there is a root context path “Bibliography” 500C, which has four descendant context paths 505C, 510C, 515C and 520C for “Author”, “Title”, “Journal” and “Date”, respectively. The Author context path 505C further has two additional descendant context paths 525C and 530C for “First Name” and “Last Name”, respectively. Further, the context path “Journal” 515C has four descendant context paths 535C, 540C, 545C and 550C for “Name”, “Issue”, “Chapter” and “Page”, respectively. For an XML-based semi-structured database, the data object depicted above in Tables 2 and 4 that is authored by J. Cox may be recorded as follows:

TABLE 6
Example of XML-based Semi-Structured Database
Entry for a Bibliography Data Object

<Bibliography>

<Author>

<LastName>Cox</LastName>
<FirstName>J.</FirstName>

</Author>
<Title>Company X races ...</Title>
<Journal>

<Name>Network World</Name>
<Issue>24</Issue>
<Chapter>8</Chapter>
<Page>26</Page>

</Journal>
<Date>2007</Date>

</Bibliography>

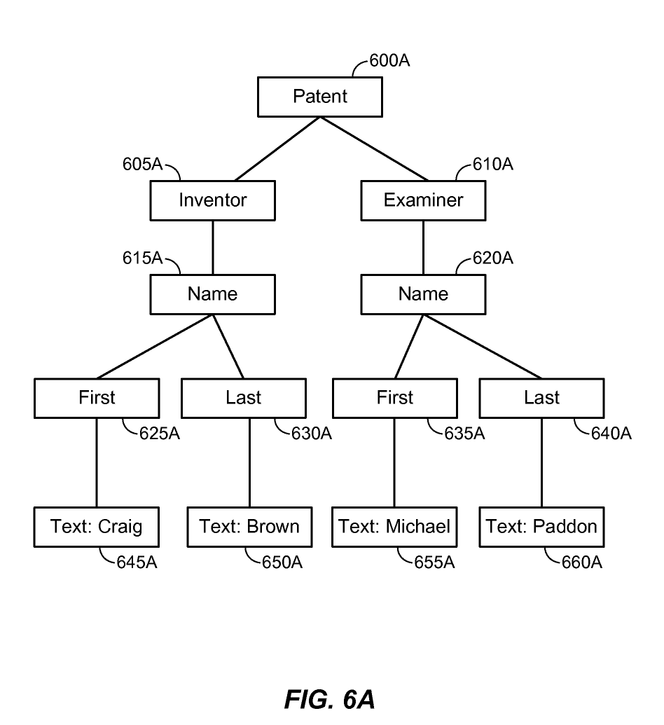

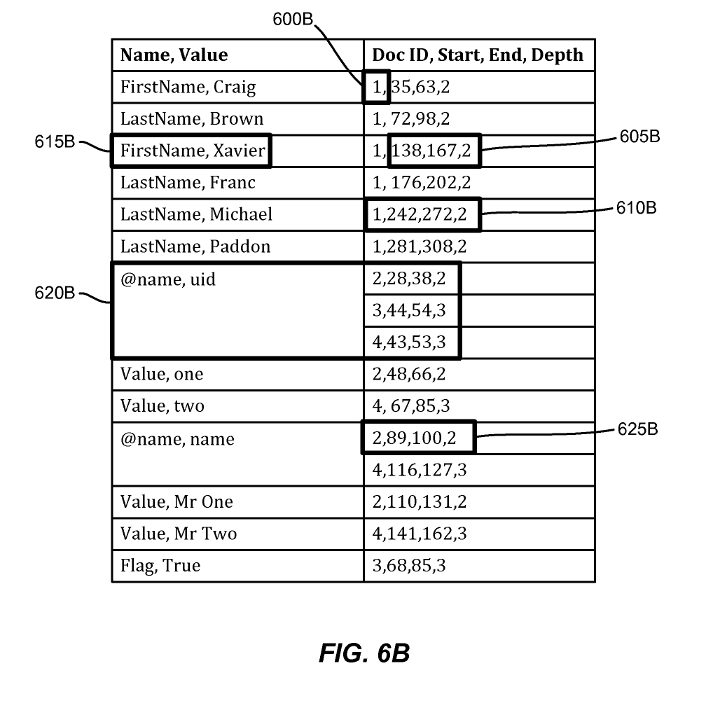

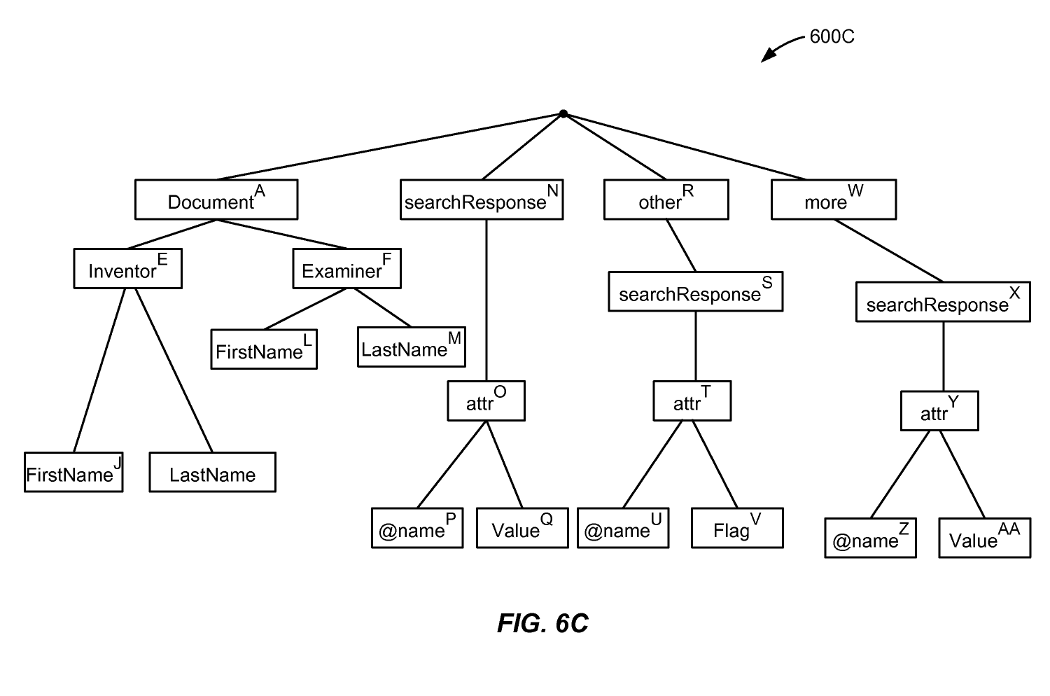

FIG. 6A illustrates an example context tree for a “Patent” document in accordance with an embodiment of the disclosure. In FIG. 6A, the document is a patent information database with a root node “Patent” 600A, which has two descendant nodes 605A and 610A for “Inventor” and “Examiner”, respectively. Each has a descendant node entitled “Name”, 615A and 620A, which in turn each have descendant nodes entitled “First” and “Last”, 625A, 630A, 635A and 640A. Further depicted in FIG. 6A are textual data objects that are stored in the respective nodes 625A-640A. In particular, for an Examiner named “Michael Paddon” and an inventor named “Craig Brown” for a particular patent document, the text “Craig” 645A is stored in a node represented by the context path /Patent/Inventor/Name/First, the text “Brown” 650A is stored in a node represented by the context path /Patent/Inventor/Name/Last, the text “Michael” 655A is stored in a node represented by the context path /Patent/Examiner/Name/First and the text “Paddon” 660A is stored in a node represented by the context path /Patent/Examiner/Name/Last. As will be discussed below in more detail, each context path can be associated with its own index entry in a Context Path Element Index, and each unique value at a particular context path can also have its own index entry in a Context Path Simple Content Index.

To put the document depicted in FIG. 6A into context with respect to XPath queries in an example where the semi-structured database corresponds to an XML database, an XPath query directed to /Patent/Inventor/Name/Last will return each data object at this context path within the tree hierarchy, in this case, “Brown”. In another scenario, the XPath query can implicate multiple nodes. For example, an XPath query directed to //Name/Last maps to both the context path /Patent/Inventor/Name/Last and the context path /Patent/Examiner/Name/Last, so this query would return each data object at any qualifying location of the tree hierarchy, in this case, both “Brown” and “Paddon”.

The document structure of a particular document in a semi-structured database can be indexed in accordance with a flat-indexing protocol or a label-path protocol. For example, in the flat-indexing protocol (sometimes referred to as a “node indexing” protocol) for an XML database, each node is indexed with a document identifier at which the node is located, a start-point and an end-point that identifies the range of the node, and a depth that indicates the node's depth in the tree hierarchy of the document (e.g., in FIG. 6A, the root node “Patent” 600A (or root context path) has depth=0, the “Inventor” and “Examiner” context paths 605A and 610A have depth=1, and so on). The range of any parent node envelops or overlaps with the range(s) of each of the parent node's respective descendant nodes. Accordingly, assuming that the document identifier is 40, the root node “Patent” 600A document depicted in FIG. 6A can be indexed as follows:

TABLE 7
Example of XML-based Tree Hierarchy Shown in FIG. 6A

<Patent>¹

<Inventor>²

<Name>³

<First>⁴Craig</First>⁵
<Last>⁶Brown</Last>⁷

</Name>⁸

</Inventor>⁹
<Examiner>¹⁰

<Name>¹¹

<First>¹²Michael</First>¹³
<Last>¹⁴Paddon</Last>¹⁵

</Name>¹⁶

</Examiner>¹⁷

</Patent>¹⁸

whereby each number represents a location of the document structure that can be used to define the respective node range, as shown in Table 8 as follows:

TABLE 8
Example of Flat-Indexing of Nodes of FIG. 6A Based on Table 7

| Name, Value | Docid, Start, End, Depth |
|---|---|
| Inventor | (40, 2, 9, 1) |
| Name | (40, 3, 8, 2), |
| | (40, 11, 16, 2) |
| Last, Brown | (40, 6, 7, 3) |
| Last, Paddon | (40, 14, 15, 3) |

Accordingly, the “Inventor” context path 605A of FIG. 6A is part of document 40, starts at location 2 and ends at location 9 as shown in Table 7, and has a depth of 1 in the tree hierarchy depicted in FIG. 6A, such that the “Inventor” context path 605A is indexed as (40,2,9,1) in Table 8. The “Name” context paths 615A and 620A of FIG. 6A are part of document 40, start at locations 3 and 11, respectively, and end at locations 8 and 16, respectively, as shown in Table 7, and have a depth of 2 in the tree hierarchy depicted in FIG. 6A, such that the “Name” context paths 615A and 620A are indexed as (40,3,8,2) and (40,11,16,2) in Table 8.

When a node stores a value, the value itself can have its own index. Accordingly, the value of “Brown” 650A as shown in FIG. 6A is part of document 40, start at location 6 and ends at location 7 as shown in Table 7, and has a depth of 3 (i.e., the depth of the node that stores the associated value of “Brown”) in the tree hierarchy depicted in FIG. 6A, such that the “Brown” value 650A is indexed as (40,6,7,3) in Table 8. The value of “Paddon” 660A as shown in FIG. 6A is part of document 40, start at location 14 and ends at location 15 as shown in Table 7, and has a depth of 3 (i.e., the depth of the node that stores the associated value of “Paddon”) in the tree hierarchy depicted in FIG. 6A, such that the “Paddon” value 660A is indexed as (40,14,15,3) in Table 8.

The flat-indexing protocol uses a brute-force approach to resolve paths. In an XML-specific example, an XPath query for /Patent/Inventor/Name/Last would require separate searches to each node in the address (i.e., “Patent”, “Inventor”, “Name” and “Last”), with the results of each query being joined with the results of each other query, as follows:

TABLE 9
Example of XPath Query for a Flat-Indexed Database

joinChild(

joinChild(

joinChild(

lookup(Patent),
lookup(Inventor)),

lookup(Name)),

lookup(Last))

Label-path indexing is described in a publication by Goldman et al. entitled “DataGuides: Enabling Query Formulation and Optimization in Semistructured Databases”. Generally, label-path indexing is an alternative to flat-indexing, whereby the path to the target node is indexed in place of the node identifier of the flat-indexing protocol, as follows:

TABLE 10
Example of XML-based Tree Hierarchy Shown in FIG. 6A

<Patent>_{A}¹

<Inventor>_{B}²

<Name>_{C}³

<First>_{D}⁴Craig</First>⁵
<Last>_{E}⁶Brown</Last>⁷

</Name>⁸

</Inventor>⁹
<Examiner>_{F}¹⁰

<Name>_{G}¹¹

<First>_{H}¹²Michael</First>¹³
<Last>_{I}¹⁴Paddon</Last>¹⁵

</Name>¹⁶

</Examiner>¹⁷

</Patent>¹⁸

whereby each number represents a location of the document structure that can be used to defined the respective node range, and each letter label (A through I) identifies a context path to a particular node or value, as shown in Table 11 as follows:

TABLE 11
Example of Label-Path Indexing of
Nodes of FIG. 6A Based on Table 10

| Context Path, Node or Value | Docid, Start, End, Depth |
|---|---|
| B (/Patent/Inventor) | (40, 2, 9, 1) |
| C (/Patent/Inventor/Name) | (40, 3, 8, 2) |
| E (/Patent/Inventor/Name/Last), Brown | (40, 6, 7, 3) |
| H(/Patent/Examiner/Name/First), Michael | (40, 12, 13, 3) |

Accordingly, with respect to Tables 10-11, the “Inventor” node 605A of FIG. 6A at the context path /Patent/Inventor (or context path B) is part of document 40, starts at location 2 and ends at location 9 as shown in Table 10, and has a depth of 1 in the tree hierarchy depicted in FIG. 6A, such that the “Inventor” context path 605A is indexed as (40,2,9,1) in Table 11. The “Name” context path 615A of FIG. 6A at the context path /Patent/Inventor/Name (or context path C) is part of document 40, starts at location 3 and ends at location 8 as shown in Table 10, and has a depth of 2 in the tree hierarchy depicted in FIG. 6A, such that the “Name” context path 615A is indexed as (40,3,8,2) in Table 11. The “Brown” value 650A of FIG. 6A at the context path /Patent/Inventor/Name/Last (or context path E) is part of document 40, starts at location 6 and ends at location 7 as shown in Table 10, and has a depth of 3 (i.e., the depth of the node that stores the “Brown” value 650A) in the tree hierarchy depicted in FIG. 6A, such that the “Brown” value 650A is indexed as (40,6,7,3) in Table 11. The “Michael” value 655A of FIG. 6A at the context path /Patent/Examiner/Name/First (or context path H) is part of document 40, starts at location 12 and ends at location 13 as shown in Table 10, and has a depth of 3 (i.e., the depth of the node that stores the “Michael” value 655A) in the tree hierarchy depicted in FIG. 6A, such that the “Michael” value 655A is indexed as (40,12,13,3) in Table 11.

More detailed XML descriptions will now be provided. At the outset, certain XML terminology is defined as follows:
Byte Offset: Byte count from the start of a file. In certain embodiments of this disclosure, it is assumed that one character is equal to one byte, but it will be appreciated by one of ordinary skill in the art this is simply for convenience of explanation and that multi-byte characters such as those used in foreign languages could also be handled in other embodiments of this disclosure.
Context ID: A unique ID for a context path. In certain embodiments of this disclosure, the Context ID is indicated via a single capital letter.
Node ID: Start byte offset, end byte offset, and depth uniquely identifying a node within a document.
Document ID/Doc ID: Identifier uniquely identifying an XML document index.
Context Path Element Index: Index where the index key contains a Context ID. Used for elements that contain both simple and complex content, where simple content means the element contains text only and complex content means elements contain other elements or a mixture or text and elements. The index value contains a Doc ID/Node ID pair.
Context Path Simple Content Index: Index where the index key contains a Context ID and a value. The index value contains a Doc ID/Node ID pair.
Flat Element Index: Index where the index key contains a node name. Used for elements that contain both simple and complex content. The index value contains a Doc ID/Node ID pair.
Flat Simple Context Index: Index where the index key contains a node name and a value. The index value contains a Doc ID/Node ID pair.
Path Instance: The route from the top of a document down to a specific node within the document.
Posting: Doc ID/Node ID tuple uniquely identifying a node within a database.
XML Document: A single well-formed XML document.

In Table 9 with respect to the flat-indexed protocol, it will be appreciated that the XPath query directed to /Patent/Inventor/Name/Last required four separate lookups for each of the nodes “Patent”, “Inventor”, “Name” and “Last”, along with three joins on the respective lookup results. By contrast, a similar XPath query directed to /Patent/Inventor/Name/Last using the label-path indexing depicted in Tables 10-11 would have a compiled query of lookup (E) based on the path /Patent/Inventor/Name/Last being defined as path “E”.

Generally, the label-path indexing protocol is more efficient for databases with a relatively low number of context paths for a given node name (e.g., less than a threshold such as 100), with the flat-indexing protocol overtaking the label-path indexing protocol in terms of query execution time as the number of context paths increases.

A number of different example XML document structures are depicted below in Table 12 including start and end byte offsets:

TABLE 12
XML Document Examples with Start and End Byte Offsets

Document 1
<Document>_{A}⁰
<Inventor>_{E}¹⁶

<FirstName>_{J}³⁵Craig</FirstName>⁶³
<LastName>_{K}⁷²Brown</LastName>⁹⁸

```
  </Inventor>¹¹⁴
  <Inventor>_{E}¹¹⁹
```

<FirstName>_{J}¹³⁸Xavier</FirstName>¹⁶⁷
<LastName>_{K}¹⁷⁶Franc</LastName>²⁰²

```
  </Inventor>²¹⁸
  <Examiner>_{F}²²³
```

<FirstName>_{L}²⁴²Michael</FirstName>²⁷²
<LastName>_{M}²⁸¹Paddon</LastName>³⁰⁸

```
  </Examiner>³²⁴
</Document>³³⁶
Document 2
<searchResponse>_{N}⁰
  <attr ²⁸name_{P} =”uid”³⁸> _{O} ²²
```

<Value>_{Q}⁴⁸one</Value>⁶⁶

```
  </attr>⁷⁸
  <attr⁸⁹name_{P}=”name”¹⁰⁰>_{O}¹¹⁰
```

<Value>_{Q}¹¹⁰Mr One</Value>¹³¹

```
  </attr>¹⁴³
</searchResponse>¹⁶¹
Document 3
<other>_{R}⁰
  <searchResponse>_{S}¹³
```

<attr⁴⁴name_{U}=”uid”⁵⁴>_{T}³⁸
<Flag>_{V}⁶⁸True</Flag>⁸⁵
</attr>¹⁰¹

```
  </searchResponse>¹²³
</other>¹³²
Document 4
<more>_{W}⁰
  <searchResponse>_{X}¹²
```

```
<attr ⁴³name_{Z}=”uid” ⁵³>_{Y}³⁷
  <Value>_{AA}⁶⁷two</Value>⁸⁵
</attr>¹⁰¹
<attr¹¹⁶name_{Z}=”name” ¹²⁷>_{Y}¹¹⁰
  <Value>_{AA}¹⁴¹Mr Two</Value>¹⁶²
</attr>¹⁷⁸
```

</searchResponse>²⁰⁰
</more>²⁰⁸

whereby each number represents a location of the document structure that can be used to defined the respective node range, and each letter label identifies a context path to a particular node or value as depicted in FIG. 6C (described below in more detail).

Next, a flat simple content index for the documents depicted in Table 12 is as follows:

TABLE 13
Flat Simple Content Index

| Name, Value | Doc ID, Start, End, Depth |
|---|---|
| FirstName, Craig | 1, 35, 63, 2 |
| LastName, Brown | 1, 72, 98, 2 |
| FirstName, Xavier | 1, 138, 167, 2 |
| LastName, Franc | 1, 176, 202, 2 |
| FirstName, Michael | 1, 242, 272, 2 |
| LastName, Paddon | 1, 281, 308, 2 |
| @name, uid | 2, 28, 38, 2 |
| | 3, 44, 54, 3 |
| | 4, 43, 53, 3 |
| Value, one | 2, 48, 66, 2 |
| Value, two | 4, 67, 85, 3 |
| @name, name | 2, 89, 100, 2 |
| | 4, 116, 127, 3 |
| Value, Mr One | 2, 110, 131, 2 |
| Value, Mr Two | 4, 141, 162, 3 |
| Flag, True | 3, 68, 85, 3 |

Next, a flat element index for the documents depicted in Table 12 is as follows,

TABLE 14
Flat Element Index

| Name | Doc ID, Start, End, Depth |
|---|---|
| document | 1, 0, 336, 0 |
| Inventor | 1, 16, 114, 1 |
| | 1, 119, 218, 1 |
| FirstName | 1, 35, 63, 2 |
| | 1, 138, 167, 2 |
| | 1, 242, 272, 2 |
| LastName | 1, 72, 98, 2 |
| | 1, 176, 202, 2 |
| | 1, 281, 308, 2 |
| Examiner | 1, 223, 324, 1 |
| searchResponse | 2, 0, 161, 0 |
| | 3, 13, 123, 1 |
| | 4, 12, 200, 1 |
| other | 3, 0, 132, 0 |
| more | 4, 0, 208, 0 |
| @name | 2, 28, 38, 2 |
| | 3, 44, 54, 3 |
| | 4, 43, 53, 3 |
| | 2, 89, 100, 2 |
| | 4, 116, 127, 3 |
| Value | 2, 48, 66, 2 |
| | 2, 110, 131, 2 |
| | 4, 67, 85, 3 |
| | 4, 141, 162, 3 |
| Flag | 3, 68, 85, 3 |

FIG. 6B illustrates an annotated version of Table 13, including examples of a document identifier 600B (e.g., “1” for document 1 of Table 12), a node identifier 605B (e.g., 138,167,2, to denote the start byte, end byte and depth of a particular node, respectively), an index value 610B (e.g., a combination of document identifier, and index value), an index key 615B (e.g., “FirstName:Xavier”), an index entry 620B (e.g., a combination of index key and each associated index value) and a posting 625B (e.g., one of a plurality of document identifier and node identifier combinations for a particular index entry).

FIG. 6C illustrates a context tree 600C with labeled context paths based on the documents depicted above in Table 12, and further based on the context tree simple content index depicted below in Table 15 and the context tree element index depicted below in Table 16:

TABLE 15
Context Tree Simple Content Index

| Context ID, Value | Doc ID, Start, End, Depth |
|---|---|
| J, Craig | 1, 35, 63, 2 |
| K, Brown | 1, 72, 98, 2 |
| J, Xavier | 1, 138, 167, 2 |
| K, Franc | 1, 176, 202, 2 |
| L, Michael | 1, 242, 272, 2 |
| M, Paddon | 1, 281, 308, 2 |
| P, uid | 2, 28, 38, 2 |
| U, uid | 3, 44, 54, 3 |
| Z, uid | 4, 43, 53, 3 |
| Q, one | 2, 48, 66, 2 |
| AA, two | 4, 67, 85, 3 |
| P, name | 2, 89, 100, 2 |
| Z, name | 4, 116, 127, 3 |
| Q, Mr One | 2, 110, 131, 2 |
| AA, Mr Two | 4, 141, 162, 3 |
| V, True | 3, 68, 85, 3 |

TABLE 16
Context Tree Element Index

| Name | Doc ID, Start, End, Depth |
|---|---|
| A | 1, 0, 336, 0 |
| E | 1, 16, 114, 1 |
| | 1, 119, 218, 1 |
| J | 1, 35, 63, 2 |
| | 1, 138, 167, 2 |
| L | 1, 242, 272, 2 |
| K | 1, 72, 98, 2 |
| | 1, 176, 202, 2 |
| M | 1, 281, 308, 2 |
| F | 1, 223, 324, 1 |
| N | 2, 0, 161, 0 |
| S | 3, 13, 123, 1 |
| X | 4, 12, 200, 1 |
| R | 3, 0, 132, 0 |
| W | 4, 0, 208, 0 |
| P | 2, 28, 38, 2 |
| | 2, 89, 100, 2 |
| U | 3, 44, 54, 3 |
| Z | 4, 43, 53, 3 |
| | 4, 116, 127, 3 |
| O | 2, 48, 66, 2 |
| | 2, 110, 131, 2 |
| AA | 4, 67, 85, 3 |
| | 4, 141, 162, 3 |
| V | 3, 68, 85, 3 |

Faceted searching is one type of search that can be conducted within a semi-structured database. In a faceted search, search criteria (or facets) configured to satisfy a series of search queries are modified in a recursive manner so as to narrow the number of search results (or nodes) returned to a client device that initiated the faceted search. For example, a first query can be performed on a book database with “fiction novels” to obtain a list of search results. This list of search results can then be used as a filter (or facet) for a second query of “1980s books” so that the second query returns a list of fiction books from the 1980s. However, executing recursive search queries on the semi-structured database is costly in terms of resource consumption, as is joining the search results from the series of search queries so as to exclude nodes that are not part of each search query's search results.

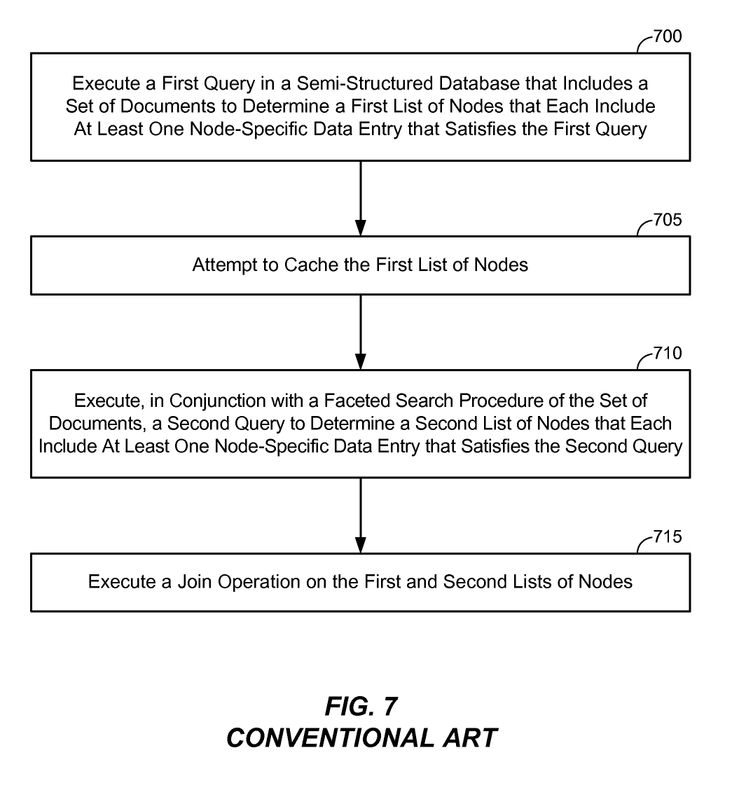

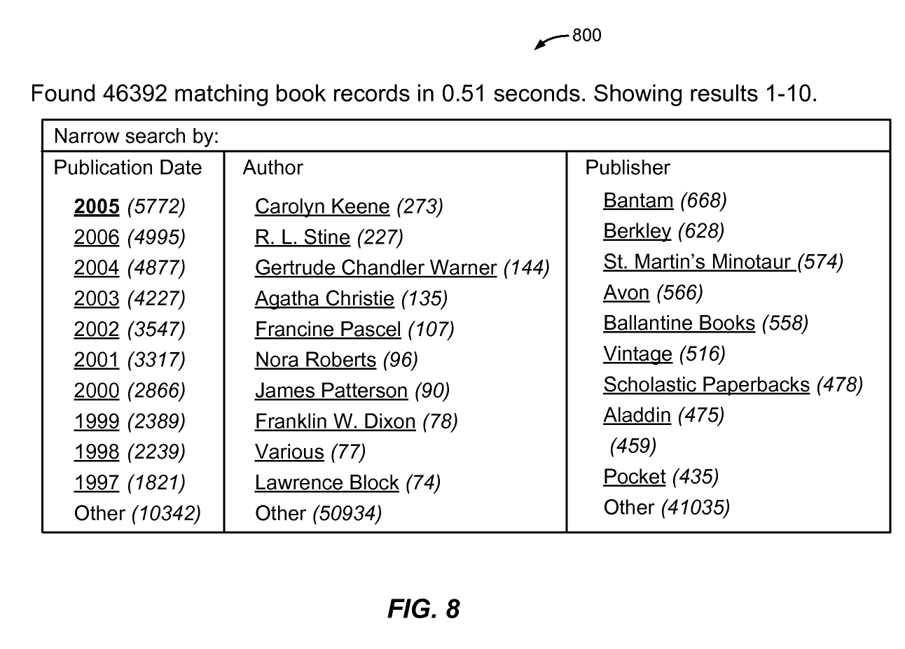

FIG. 7 illustrates a conventional faceted search procedure that is performed on a set of documents in a semi-structured database. Referring to FIG. 7, in block 700, the semi-structured database server 170 executes a first search query (e.g., received from a client device) in the semi-structured database to determine a first list of nodes among the set of documents that each include at least one node-specific data entry (or value) that satisfies a search query. For example, the semi-structured database can correspond to a book database that stores information related for books. The first list of nodes (i.e., the search results of the first query) with the initial search criteria (e.g., “fiction” and “novel”) can then act as a facet for future search queries. The facet in this example may include a high number of search results, as depicted in facet prompt screen 800 of FIG. 8 whereby 46392 book records in the book database match the search. The facet prompt screen 800 is an example of the data that can be sent to the client device which requested the first query in order to prompt a user thereof to select additional search filters that use the first list of nodes as a facet in order to narrow down the high number of search results obtained from the first query. In block 705, the semi-structured database server 170 may attempt to cache the first list of nodes in a cache memory (e.g., a RAM, a quick-access portion of 315 of FIG. 3 or the volatile memory 402 or the disk drive 403 of FIG. 4, etc.). By keeping the first list of nodes in a cache, the semi-structured database server 170 will be able to more quickly perform Boolean operations (e.g., join, intersection, etc.) with search results from subsequent search queries on different facets. However, it will be appreciated that the first list of nodes may be fairly high (as in the example of FIG. 8), so caching this many search results as a facet may be costly in terms of performance.

Upon being prompted with the facet prompt screen 800, the user of the client device may select one or more of the illustrated search filters (e.g., “2002” and “Agatha Christie”, etc.) to narrow down the first list of nodes, in response to which the semi-structured database server 170 executes a second query by searching the set of documents in the semi-structured database to determine a second list of nodes that each include one or more node-specific data entries (or values) that satisfy the second search query, in block 710. Upon obtaining the second list of nodes, the semi-structured database server 170 executes a join operation the first and second list of nodes in order to provide a reduced set of search results to the user of the client device, in block 715. The join operation of block 715 functions to exclude search results in the second list of nodes which do not match any corresponding search result in the first list of nodes, such that the first list of nodes can be characterized as a facet (or filter) of the second query.

As will be appreciated, caching a large number of search results for use as a facet in block 705 of FIG. 7 can be taxing on the resources available to the semi-structured database server 170, and performing the join operation in block 715 between the different search results (or lists of nodes) is also demanding in terms of processing resources even if the caching in block 705 is successful, especially for large databases that provide a high number of search results for the various facets. Embodiments of the disclosure are thereby directed to using a Bloom filter so as to reduce the resources associated with faceted search procedures in a semi-structured database environment.

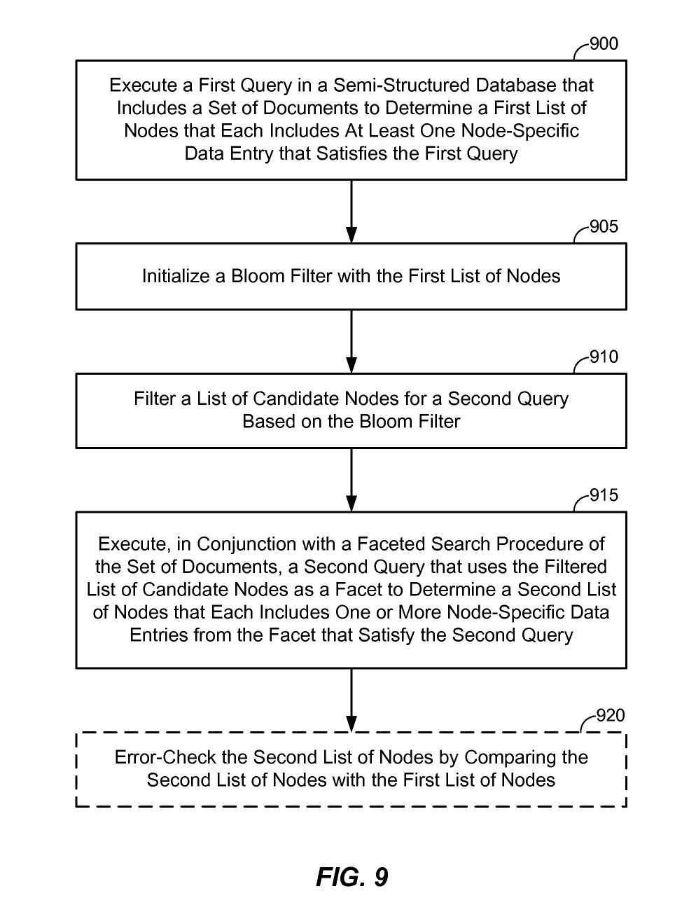

FIG. 9 illustrates an example faceted search procedure that is performed on a set of documents in a semi-structured database in accordance with an embodiment of the disclosure. The set of documents can include a single document or multiple documents. For convenience of explanation, the operations illustrated in FIG. 9 are described as being performed by the semi-structured database server 170 which is communicatively linked to one or more client devices that are configured to specify search criteria (or facets) upon which the semi-structured database server 170 conducts search queries.

Referring to FIG. 9, the semi-structured database server 170 executes a first query (e.g., received from a client device) in a semi-structured database to determine a first list of nodes, among the set of documents, that each includes at least one node-specific data entry (or value) that satisfies the first query, in block 900 (e.g., similar to block 700 of FIG. 7). In addition to the first list of nodes, the semi-structured database server 170 may also obtain a list of document identifiers for each document that includes any node in the first list of nodes.

Similar to the example described above with respect to FIG. 7, the semi-structured database of FIG. 9 can correspond, in an example, to a book database that stores information related for books. The first query may include initial search criteria (e.g., “fiction” and “novel”) that results in a high number of search results, as depicted in facet prompt screen 800 of FIG. 8 whereby 46392 book records in the book database match the search. The facet prompt screen 800 is an example of the data that can be sent to the client device which requested the first query in order to prompt a user thereof to select additional search filters to narrow down the high number of search results obtained from the first query.

In one embodiment, as shown in FIG. 9, the semi-structured database server 170 uses the first list of nodes to initialize a Bloom filter, in block 905. In an example, the Bloom filter is initiated instead of re-using the first list of nodes as shown in block 705 of FIG. 7. In another example, caching of the first list of nodes may also be performed in conjunction with initiation of the Bloom filter in block 905 (e.g., in the cache memory of the semi-structured database server 170 if sufficient resources are available). Bloom filters are compact data structures for probabilistic representation of a set in order to support membership queries (e.g., queries that ask: “Is element X in set Y?”). Using Bloom filters creates a risk of false positives in membership queries; that is, queries might incorrectly recognize an element as a member of the set. In an example, the Bloom filter initialized at block 905 may be configured to be applied to other lists of nodes in order to determine whether the listed nodes are also part of the first list of nodes. In an example, the Bloom filter initialized at block 905 may be stored in the cache memory of the semi-structured database server 170.

In an example, to initialize the Bloom filter at block 905, an array of m bits is generated which, at first, are each initialized to a first logic state (e.g., a de-asserted state, such as “0”). Each node in the first list of nodes is iteratively added to the array of m bits by applying k independent hash functions to node-specific data (e.g., the node's identifier or path), and using the resulting k hash values to address and assert (e.g., set to a second logic value, such as “1”) a bit within the array of bits. For each node added, k bits within the array will be asserted. When this is completed, the Bloom filter is said to be initialized with the first list of nodes. A candidate node can be tested to determine whether the candidate node is already part of the first list of nodes by applying the k hash functions to the node-specific data of the candidate node and then comparing each resulting hash address value to the Bloom filter. If any of the k bits for the candidate node are set to the first logic value (or de-asserted), the candidate node can be ruled out as being part of the first list of nodes. If each of the k bits are asserted, there is a relatively high likelihood that the candidate node is already part of the first list of nodes, although this is not guaranteed since the k bits may have been asserted based on the hash values of other nodes in the first list of nodes. Bloom filters are well-known in the art, and will not be described in further detail for the sake of brevity.

Referring back to FIG. 9, upon being prompted with the facet prompt screen 800, the user of the client device may select one or more search filters (e.g., “2002” and “Agatha Christie”, etc.) to be executed as a second query in order to narrow down the first list of nodes. Instead of executing the second query on the entire set of documents of the semi-structured database (e.g., as at 710 of FIG. 7), in block 910, the semi-structured database server 170 filters a list of candidate nodes (e.g., each node in each of the set of documents for the semi-structured database) based on the Bloom filter. For example, the semi-structured database server 170 can apply k independent hash functions to the node-specific data (e.g., the node's identifier or path) of each node in the list of candidate nodes, similar to when the Bloom filter was initiated at block 905. Each node in the list of candidate nodes that has each of its corresponding k bits in the bit array (or Bloom filter) can be assumed to already be in the first list of nodes. Any nodes in the list of candidate nodes that are determined not to be in the first list of nodes using this process can be filtered (or excluded) from the list of candidate nodes.

After the list of candidate nodes is filtered at block 910, in block 915, the semi-structured database server 170 executes the second query by using the filtered list of candidate nodes (as opposed to the entire list of candidate nodes and/or all nodes in the set of documents) as a facet to determine a second list of nodes that each includes one or more node-specific data entries from the facet that satisfy the second query.

As will be appreciated, the filtering performed in block 910 may result in a few false positives in the filtered list of candidate nodes, for example, due to the Bloom filter coincidentally having a set of asserted bits in the bit array that align with one or more nodes in the list of candidate nodes which are not actually part of the first list of nodes. In some examples, in block 920, the semi-structured database server 170 can error-check the second list of nodes by comparing the second list of nodes with the first list of nodes (e.g., via a join operation). The error-checking in block 920 (e.g., a join operation) can be similar in some respects to block 715, except that the error-checking of block 920 is most likely conducted with less information by virtue of the filtering that occurs at block 910. This may reduce the overall resource consumption of the error-checking of block 920 at the semi-structured database server 170. While not shown explicitly in FIG. 9, the second list of nodes derived at block 915 and/or block 920 can be returned as search results to the client device that initiated the faceted search procedure. If the error-checking (or join operation) in block 920 is not performed and potential false positives are included in the filtered list of candidate nodes at block 915 (potentially resulting in one or more search results being contained in the second list of nodes that did not appear in the first list of nodes), the facet is referred to as a “fuzzy” facet.

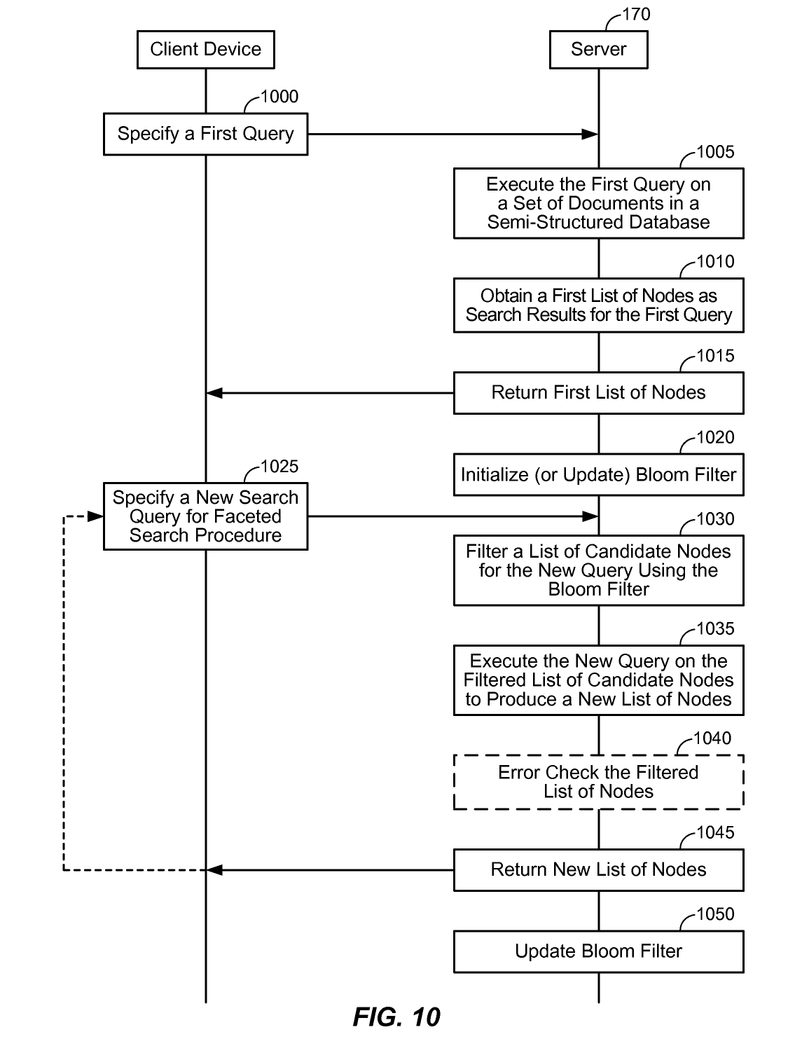

FIG. 10 illustrates a more detailed implementation example of the process of FIG. 9 in accordance with at least one embodiment of the disclosure. Referring to FIG. 10, in block 1000, a client device (e.g., any of UEs 1 . . . N as shown in FIG. 1, UE 200A or 200B as shown in FIG. 2, etc.) may send a request to the semi-structured database server 170 that specifies one or more search parameters for a first query. In response to receiving the first query in block 1000, in block 1005, the semi-structured database server 170 executes the first query on a set of documents in a semi-structured database, and obtains a first list of nodes as search results for the first query, in block 1010 (e.g., as in block 900 of FIG. 9). In block 1015, the semi-structured database server 170 returns the first list of nodes to the client device, and in block 1020 initializes a Bloom filter that is configured to test whether any candidate nodes are in the first list of nodes (e.g., as in block 905 of FIG. 9).

At this point of the process of FIG. 10, blocks 1010-1020 may repeat in an iterative manner as will now be explained. In block 1025, the client device sends a new request to the semi-structured database server 170 that specifies one or more search parameters for a new query to be executed while using the first list of nodes as a facet in association with a faceted search procedure. As noted above with respect to FIG. 9, the new query may be the result of a user prompt screen as depicted in 800 of FIG. 8, whereby the user is permitted to select additional filters (or search criteria) in order to narrow the scope of the first list of nodes so as to obtain a reduced set of more relevant results. In one example, in block 1030, the semi-structured database server 170 limits the scope of the new query by filtering a list of candidate nodes (e.g., each node in each of the set of documents for the semi-structured database) based on the Bloom filter (e.g., as in block 910 of FIG. 9). In block 1035, the semi-structured database server 170 then executes the new query using the filtered list of candidate nodes (as opposed to the entire list of candidate nodes and/or all nodes in the set of documents) as a facet to determine a second list of nodes that each includes one or more node-specific data entries from the facet that satisfy the new query (e.g., as in block 915 of FIG. 9). In an example, at block 1040, the semi-structured database server 170 may error-check the second list of nodes (e.g., as in block 920 of FIG. 9), and then return the second list of nodes to the client device in block 1045.

In one example, in block 1050, the semi-structured database server 170 updates (or re-initializes) the Bloom filter using the second list of nodes provided to the client device. For example, the Bloom filter is initialized to the first list of nodes at block 1020, but the second list of nodes is likely to be smaller than the first list of nodes. Accordingly, updating or re-initializing the Bloom filter to the second list of nodes at block 1055 will help to narrow any further queries issued in association with the faceted search procedure. After block 1045, if the user determines to specify additional search parameters in a new query for further narrowing the search results in association with the faceted search procedure, the process returns to block 1025, after which blocks 1025-1050 can repeat until the faceted search procedure terminates. For example, the filtering of block 1030 for the new query can be based upon the updated Bloom filter from block 1050. If performed, the error-check of block 1040 can compare a current list of nodes obtained from execution of the search query at block 1035 to one or more lists of nodes returned for each previous query conducted in association with the faceted search procedure. For example, for an Nth search query in the process depicted in FIG. 10, the Nth list of nodes obtained via execution of the Nth query at block 1035 may be error checked against the N−1th list of nodes obtained via execution of the N−1th query, and so on.

While the processes are described as being performed by the semi-structured database server 170, as noted above, the semi-structured database server 170 can be implemented as a client device, a network server, an application that is embedded on a client device and/or network server, and so on. Hence, the apparatus that executes the processes in various example embodiments is intended to be interpreted broadly.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative embodiments of the disclosure, it should be noted that various changes and modifications could be made herein without departing from the scope of the disclosure as defined by the appended claims. The functions, steps and/or actions of the method claims in accordance with the embodiments of the disclosure described herein need not be performed in any particular order. Furthermore, although elements of the disclosure may be described or claimed in the singular, the plural is contemplated unless limitation to the singular is explicitly stated.

What is claimed is:

1. A method of performing a search within a semi-structured database that is storing a set of documents, each document in the set of documents being organized with a tree-structure that contains a plurality of nodes, the plurality of nodes for each document in the set of documents including a root node and at least one non-root node, each of the plurality of nodes including a set of node-specific data entries, comprising:
executing, among the set of documents, a first query to determine a first list of nodes that each include at least one node-specific data entry that satisfies the first query;
initializing a Bloom filter with the first list of nodes;
filtering a list of candidate nodes for a second query based on the Bloom filter; and
executing, in conjunction with a faceted search procedure of the set of documents, the second query that uses the filtered list of candidate nodes as a facet to determine a second list of nodes that each includes one or more node-specific data entries from the facet that satisfy the second query.

2. The method of claim 1,
wherein the semi-structured database is an Extensible Markup Language (XML) database, or
wherein the semi-structured database is a JavaScript Object Notation (JSON) database.

3. The method of claim 1, wherein the plurality of nodes are logical nodes deployed at one or more physical devices.

4. The method of claim 1,
wherein the set of documents includes a single document, or
wherein the set of documents includes multiple documents.

5. The method claim 1, further comprising:
error-checking the second list of nodes by comparing the second list of nodes to the first list of nodes in order to remove, from the second list of nodes, any nodes that are falsely indicated as being part of the first list of nodes by the Bloom filter.

6. The method of claim 5, further comprising:
returning the error-checked second list of nodes to a client device that initiated the faceted search procedure.

7. The method of claim 1, wherein the faceted search procedure is a fuzzy faceted search procedure that includes potential for error in the second list of nodes returned to the client device.

8. The method of claim 1, further comprising:
updating the Bloom filter based on the second list of nodes.

9. The method of claim 8, further comprising:
filtering the list of candidate nodes for a third query based on the updated Bloom filter to produce a second filtered list of candidate nodes;
executing, in conjunction with the faceted search procedure of the set of documents, a third query that uses the second filtered list of candidate nodes as another facet to determine a third list of nodes that each includes one or more node-specific data entries from the facet that satisfy the third query.

10. The method of claim 9, further comprising:
error-checking the third list of nodes by comparing the third list of nodes to the first and/or second lists of nodes in order to remove, from the third list of nodes, any nodes that are falsely indicated as being part of the first and/or second lists of nodes by the updated Bloom filter.

11. The method of claim 1,
wherein the Bloom filter is configured to test whether each candidate node in a list of candidate nodes is in the first list of nodes, and
wherein the filtering removes, from the list of candidate nodes, any nodes that are determined not to be among the first list of nodes.

12. The method of claim 1, wherein the initializing includes:
setting each bit in a bit array to a first logic value,
applying one or more hash functions to each node identifier in the first list of nodes to identify a first set of node-specific locations in the bit array, and
transitioning bits at each of the first set of node-specific locations for each node in the first list of nodes to a second logic value to produce the Bloom filter.

13. The method of claim 12, wherein the filtering includes:
applying the one or more hash functions to each node identifier in the list of candidate nodes to identify a second set of node-specific locations in the bit array, and
removing, from the list of candidate nodes, any nodes with a node identifier that hashes to one or more node-specific locations in the bit array that are set to the first logic value.

14. A server that is configured to perform a search within a semi-structured database that is storing a set of documents, each document in the set of documents being organized with a tree-structure that contains a plurality of nodes, the plurality of nodes for each document in the set of documents including a root node and at least one non-root node, each of the plurality of nodes including a set of node-specific data entries, comprising:
means for executing, among the set of documents, a first query to determine a first list of nodes that each include at least one node-specific data entry that satisfies the first query;
means for initializing a Bloom filter with the first list of nodes;
means for filtering a list of candidate nodes for a second query based on the Bloom filter; and
means for executing, in conjunction with a faceted search procedure of the set of documents, the second query that uses the filtered list of candidate nodes as a facet to determine a second list of nodes that each includes one or more node-specific data entries from the facet that satisfy the second query.

15. The server claim 14, further comprising:
means for error-checking the second list of nodes by comparing the second list of nodes to the first list of nodes in order to remove, from the second list of nodes, any nodes that are falsely indicated as being part of the first list of nodes by the Bloom filter.

16. The server of claim 15, further comprising:
means for returning the error-checked second list of nodes to a client device that initiated the faceted search procedure.

17. The server of claim 14, further comprising:
means for returning the second list of nodes to a client device that initiated the faceted search procedure without error-checking the second list of nodes against the first list of nodes,
wherein the faceted search procedure is a fuzzy faceted search procedure that includes potential for error in the second list of nodes returned to the client device.

18. The server of claim 14, further comprising:
means for updating the Bloom filter based on the second list of nodes.

19. The server of claim 18, further comprising:
means for filtering the list of candidate nodes for a third query based on the updated Bloom filter to produce a second filtered list of candidate nodes;
means for executing, in conjunction with the faceted search procedure of the set of documents, a third query that uses the second filtered list of candidate nodes as another facet to determine a third list of nodes that each includes one or more node-specific data entries from the facet that satisfy the third query.

20. A server that is configured to perform a search within a semi-structured database that is storing a set of documents, each document in the set of documents being organized with a tree-structure that contains a plurality of nodes, the plurality of nodes for each document in the set of documents including a root node and at least one non-root node, each of the plurality of nodes including a set of node-specific data entries, comprising:
logic configured to execute, among the set of documents, a first query to determine a first list of nodes that each include at least one node-specific data entry that satisfies the first query;
logic configured to initialize a Bloom filter with the first list of nodes;
logic configured to filter a list of candidate nodes for a second query based on the Bloom filter; and
logic configured to execute, in conjunction with a faceted search procedure of the set of documents, the second query that uses the filtered list of candidate nodes as a facet to determine a second list of nodes that each includes one or more node-specific data entries from the facet that satisfy the second query.

21. The server claim 20, further comprising:
logic configured to error-check the second list of nodes by comparing the second list of nodes to the first list of nodes in order to remove, from the second list of nodes, any nodes that are falsely indicated as being part of the first list of nodes by the Bloom filter.

22. The server of claim 21, further comprising:
logic configured to return the error-checked second list of nodes to a client device that initiated the faceted search procedure.

23. The server of claim 20, further comprising:
logic configured to return the second list of nodes to a client device that initiated the faceted search procedure without error-checking the second list of nodes against the first list of nodes,
wherein the faceted search procedure is a fuzzy faceted search procedure that includes potential for error in the second list of nodes returned to the client device.

24. The server of claim 20, further comprising:
logic configured to update the Bloom filter based on the second list of nodes.

25. The server of claim 24, further comprising:
logic configured to filter the list of candidate nodes for a third query based on the updated Bloom filter to produce a second filtered list of candidate nodes;
logic configured to execute, in conjunction with the faceted search procedure of the set of documents, a third query that uses the second filtered list of candidate nodes as another facet to determine a third list of nodes that each includes one or more node-specific data entries from the facet that satisfy the third query.

26. A non-transitory computer-readable medium containing instructions stored thereon, which, when executed by a server that is configured to perform a search within a semi-structured database that is storing a set of documents, each document in the set of documents being organized with a tree-structure that contains a plurality of nodes, the plurality of nodes for each document in the set of documents including a root node and at least one non-root node, each of the plurality of nodes including a set of node-specific data entries, cause the server to perform operations, the instructions comprising:
at least one instruction to cause the server to execute, among the set of documents, a first query to determine a first list of nodes that each include at least one node-specific data entry that satisfies the first query;
at least one instruction to cause the server to initialize a Bloom filter with the first list of nodes;
at least one instruction to cause the server to filter a list of candidate nodes for a second query based on the Bloom filter; and
at least one instruction to cause the server to execute, in conjunction with a faceted search procedure of the set of documents, the second query that uses the filtered list of candidate nodes as a facet to determine a second list of nodes that each includes one or more node-specific data entries from the facet that satisfy the second query.

27. The non-transitory computer-readable medium claim 26, further comprising:
at least one instruction to cause the server to error-check the second list of nodes by comparing the second list of nodes to the first list of nodes in order to remove, from the second list of nodes, any nodes that are falsely indicated as being part of the first list of nodes by the Bloom filter.

28. The non-transitory computer-readable medium of claim 27, further comprising:
at least one instruction to cause the server to return the error-checked second list of nodes to a client device that initiated the faceted search procedure.

29. The non-transitory computer-readable medium of claim 26, further comprising:
at least one instruction to cause the server to return the second list of nodes to a client device that initiated the faceted search procedure without error-checking the second list of nodes against the first list of nodes,
wherein the faceted search procedure is a fuzzy faceted search procedure that includes potential for error in the second list of nodes returned to the client device.

30. The non-transitory computer-readable medium of claim 26, further comprising:
at least one instruction to cause the server to update the Bloom filter based on the second list of nodes.
